(19) United States
(12) Patent Application Publication
(10) Pub. No.: US 2025/0087044 A1
(43) Pub. Date: Mar. 13, 2025

(54) RISK PROFILING SYSTEM FOR WAGER PLACEMENT USING ANONYMOUS PLAYER RECOGNITION

(71) Applicant: SB22, Inc., Dallas, TX (US)

(72) Inventor: Vladimir Jovanovic, Belgrade (RS)

(21) Appl. No.: 18/883,408

(22) Filed: Sep. 12, 2024

Related U.S. Application Data
(60) Provisional application No. 63/582,228, filed on Sep. 12, 2023.

(51) Int. Cl. G07F 17/32

(52) U.S. Cl. CPC G07F 17/3206; G07F 17/3237; G07F 17/3241; G07F 17/3288

(57) ABSTRACT

The present disclosure relates to a fully automated system for player identification for risk profiling purposes that can be used in conjunction with an unmanned wagering system, such as, for example a sports wagering kiosk, based on audio-visual biometric recognition and AI pattern recognition. In aspects, a sports wagering kiosk includes components to detect biometrics information, such as a camera for facial detection, a fingerprint scanner, a retina scanner, a microphone for voice recognition, etc. The collected biometric information is processed using machine learning and/or other identification algorithms heuristics to create an identifier for the player. In aspects, the identifier generated is uniquely identifiable, such that it can be used to identify the same player across multiple interactions using different devices.

### CROSS-REFERENCE TO RELATED APPLICATIONS

This application claims priority to U.S. Provisional Patent Application Ser. No. 63/582,228, filed Sep. 12, 2023, entitled “RISK PROFILING SYSTEM FOR WAGER PLACEMENT USING ANONYMOUS PLAYER RECOGNITION,” which is incorporated herein by reference in its entirety.

### BACKGROUND

A use case for a sports wager placement kiosk involves a player who deposits funds and places a wager without needing to log in to their personal account. In such situations, the wagering operator is exposed to increased risk of uncontrolled liability and anti-money laundering rules violation, since know your customer (KYC) identification is not performed. Additionally, the player is unable to utilize responsible gaming tools such as self-exclusion/time out, deposit limits, and other procedures as appropriate under regulatory rules.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to a fully automated system for player identification for risk profiling purposes than can be used in conjunction with an unmanned wagering system, such as, for example a sports wager placement kiosk, based on audio-visual biometric recognition and AI pattern recognition. In aspects, a sports wagering kiosk includes components to detect biometrics information, such as a camera for facial detection, a fingerprint scanner, a retina scanner, a microphone for voice recognition, etc. The collected biometric information is processed using machine learning and/or other identification algorithms heuristics to create an identifier for the player. The biometric information can be used to associate the player with a risk profile.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary risk profiling system, according to aspects described herein.

FIG. 2 depicts an exemplary method for identifying an existing risk profile using biometrics information.

FIG. 3 depicts an exemplary method for determine whether the player's current wager presents a risk in acceptance.

FIG. 4 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Aspects of the present disclosure relate to a fully automated system for player identification for risk profiling purposes that can be used in conjunction with an unmanned wagering system, such as, for example a sports wagering kiosk, based on audio-visual biometric recognition and AI pattern recognition. In aspects, a sports wagering kiosk includes components to detect biometrics information, such as a camera for facial detection, a fingerprint scanner, a retina scanner, a microphone for voice recognition, etc. The collected biometric information is processed using machine learning and/or other identification algorithms heuristics to create an identifier for the player. In aspects, the identifier generated is uniquely identifiable, such that it can be used to identify the same player across multiple interactions using different devices. However, the identifier does not contain personally identifiable information. That is, the identifier is generated based upon the player's biometrics data to create an identifier that cannot be used to recreate the collected biometric information used to generate the identifier. For example, if facial recognition is used to create the identifier, the identifier cannot be used to recreate the player's face. As such, the identifier is anonymized.

The identifier is associated with a player profile which can be used to track the player's transaction history. By doing so, player risk profiles are created and updated through continuous biometric information acquisition and wagering patterns collection on multiple kiosk devices (or other wagering devices). When a new wager is received, the player's risk profile is analyzed to determine if the wager should be accepted. Through the creation of the risk profiles, wagers can automatically be accepted in accordance with the laws and regulations of the jurisdiction in which the player is placing the wager. Additionally, the risk profiles allow for compliance with anti-money laundering regulations and procedures. Finally, the use of the profiles allows for the application of responsible gaming tools to be applied by aspects of the disclosure, such that limits and exclusions would be enacted simultaneously on all of the physical kiosks connected to a centralized wagering system which manages the player profile. The risk profiles generated by aspects of the present disclosure are generated in a manner which can only be accessed by the wagering systems disclosed herein and are not matched with any personal identification information. Further, the flexibility of the disclosed system and methods allow for the collection and retention of data in accordance with jurisdictional regulations.

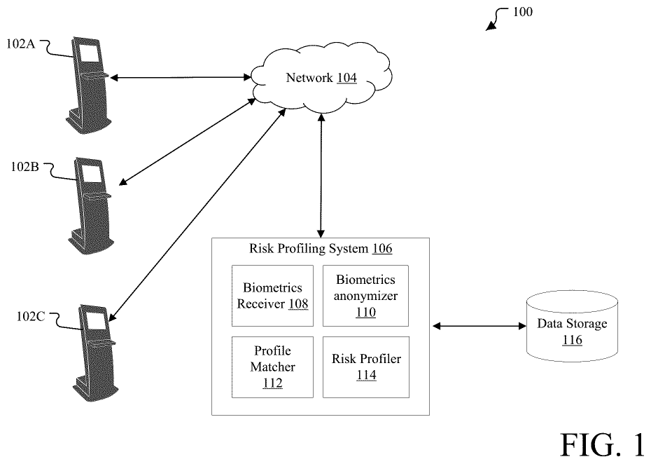

FIG. 1 depicts an exemplary risk profiling system 100, according to aspects described herein. As shown in FIG. 1, a number of exemplary kiosks, such as sports wagering kiosks 102A-102C are connected to each other and a risk profiling system 106 via a network 104. Network 104 may be any type of network, such as, for example, a LAN, a WAN, a near-field communications network, a cellular broadband network, point-to-point network, a Wi-Fi network, the Internet, etc., and may include one or more of wired, wireless, and/or optical portions. In aspects, a kiosk, such as sports wagering kiosk 102A, may be any type of kiosk capable of receiving currency or credits from a player, displaying selectable betting options, and confirming and placing a wager on a selected betting option. In aspects, a sports wagering kiosk, such as kiosk 102A, may be any type of kiosk capable of receiving currency or credits from a player, displaying selectable betting options, and confirming and placing a wager on a selected betting option. In examples, the kiosk may be operable to receive a wager amount in the form of physical currency (e.g., paper money and/or coins), via a credit or debit/card, or digital currency (e.g., electronic bank transfers, bitcoin, etc.). The kiosk may include a payment receptacle operable to receive the wager amount. The payment receptacle may be a bill or coin acceptor, operable to receive cash or coins and identify the denominations of currency received, a credit card reader operable to read credit card magnetic strips, credit card chips, or accept credit payments using near field communication (NFC). Alternatively, or additionally, the payment receptacle may be an NFC reader able to accept payment via smartphone NFC communication. In still further aspects, the payment receptacle may be in the form of a display, for example, by displaying a QR code or other payment details that can be used to facilitate wager placement via an application on a smartphone or other device. The kiosk may also include a printer operable to print out transaction receipts, wager tickets, etc. In still further embodiments, the kiosk may include a winnings dispenser operable to read wagers (e.g., wager tickets, QR codes representing the wager, etc.) and to dispense winnings in the form of currency or a ticket which can be used to collect winnings. The sports wagering kiosk, such as kiosk 102A, may also include an interface capable of receiving biometric data, such as a camera, microphone, retina scanner, fingerprint reader, etc. The kiosk 102A also includes a display capable of displaying wagering opportunities and an interface capable of receiving wagers. The display may be a touchscreen display and the interface may be a graphical user interface operable to display and receive selection of wagering opportunities. Alternatively, or additionally, a physical interface, such as buttons, a dial, etc., operable to navigate and receive selections of displayed opportunities may be included as part of the kiosk 102A.

The sports wagering kiosks 102A-C also include audio-visual acquisition equipment, such as a camera, a microphone, a fingerprint scanner, retina scanner, etc. embedded in the wagering kiosk. As such, the sports wagering kiosks 102A-C are operable to collect a player's biometric data when the player uses the sports wagering kiosks 102A-C. Exemplary biometric data includes facial details, voice, retinal scan, fingerprints, etc. One of skill in the art will appreciate that any type of biometric data can be employed with the aspects herein so long as the kiosk includes an appropriate reader to collect said biometric data (e.g., a camera, fingerprint scanner, microphone, etc.). As will be described in further detail, the collected biometric data is used to generate a personal identifier in a manner that does not require the storage of biometric data. In doing so, the system 100 is able to uniquely identify players without storing or maintaining the player's personally identifiable information.

In one aspect, the biometric information collected by the kiosk can be processed by a risk profiling system 106. The risk profiling system 106 may reside on a remote device, such as a server or within a cloud network. Alternatively, the risk profiling system 106 may be integrated into the sports wagering kiosks 102A-C (not shown in FIG. 1.). When the risk profiling system 106 is located on a remote device, the biometric information collected by the sports wagering kiosk can be encrypted and transmitted via network 104.

As shown in FIG. 1, the risk profiling system 106 can include a biometrics receiver 108, a biometrics anonymizer 110, a profile manager 112, and a risk profiler 114. In aspects, the biometrics receiver 108 is operable to receive the biometrics information collected at the sports wagering kiosks 102A-C using a scanner, fingerprint analyzer, microphone, etc. The biometrics receiver 108 is further operable to decrypt the biometrics information and perform pre-processing of the biometrics information (e.g., generate feature vectors for a machine learning model, normalize biometric data, etc.) prior to providing the received biometrics data to the biometrics anonymizer 110.

The biometrics anonymizer is operable to process the biometrics information to generate a unique identifier for a player. In aspects, the unique identifier is generated in manner that obscures the player's biometric data. That is, the player's biometrics information (e.g., face, thumbprint or fingerprint, voice, retinal scan, etc.) cannot be recreated based upon the unique identifier generated using the biometrics anonymizer 110. The biometrics anonymizer may employ various different processes to generate the unique identifier, such as by use of a pattern matching algorithm, heuristics, or machine learning models to generate the unique identifier. Different processes may be applied to generate the unique identifier so long as the processes employed by the biometrics anonymizer are deterministic. That is, given the same biometrics information, the biometrics analyzer will generate the same unique identifier. In doing so, the biometrics information can be discarded upon generation of the unique identifier, thereby allowing the system 100 to identify a player without storing any of the player's personal information or biometrics information.

Upon generating the unique identifier, the unique identifier is provided to the profile matcher 112. The profile matcher 112 determines whether the system has stored a player risk profile that is associated with the unique identifier. For example, the unique identifier generated by the biometrics anonymizer 110 is compared against a database of stored identifiers to determine if the unique identifier was previously generated by the risk profiling system 106 and associated with an existing player risk profile. If a player risk profile does not exist, that is, when the unique identifier does not match an identifier in the risk profiling system 106, the profile matcher 112 is further operable to generate a new player risk profile and associate the unique identifier with the new player risk profile. When a risk profile associated with the unique identifier exists, the profile matcher retrieves the player risk profile, for example, from player risk profile data store 116, and provides the retrieved risk profile to the risk profiler 114.

In aspects, the player risk profile stores information related to the player's past wagers. The risk profiler 114 analyzes the player's past wagers against a current wager placed by the player to determine whether there is risk involved with accepting the new wager. As used herein, the risk involved is related to jurisdictional regulations, compliance procedures, and/or anti-money laundering procedures. Various different machine learning models, heuristics, and/or pattern matching algorithms may be employed by the risk profiler 114 to analyze the player's wager history to determine whether the player's actions comply with the applicable jurisdictional regulations, compliance procedures, and/or anti-money laundering procedures. If the player's actions are in compliance, the risk profile can allow the current wager to be placed. If, however, the player's actions run afoul of applicable jurisdictional regulations, compliance procedures, and/or anti-money laundering procedures, the wager may be rejected, and one or more risk management actions may be performed. Additionally, or alternatively, even if the player's wager is allowed under local jurisdictions, the risk profiler 114 can apply responsible gaming tools, for example, by enacting limits on the wager or exclusions of the wager. Regardless of whether the new wager is accepted or rejected, the player's risk profile may be updated to include the new wager.

The risk profiling system 100 provides a flexible, safe solution to comply with applicable jurisdictional regulations, compliance procedures, anti-money laundering procedures, and/or responsible gaming procedures to ensure that wagers are properly accepted across various different sports wagering kiosks or sports books without requiring the storage of personal information or personal identifiable information.

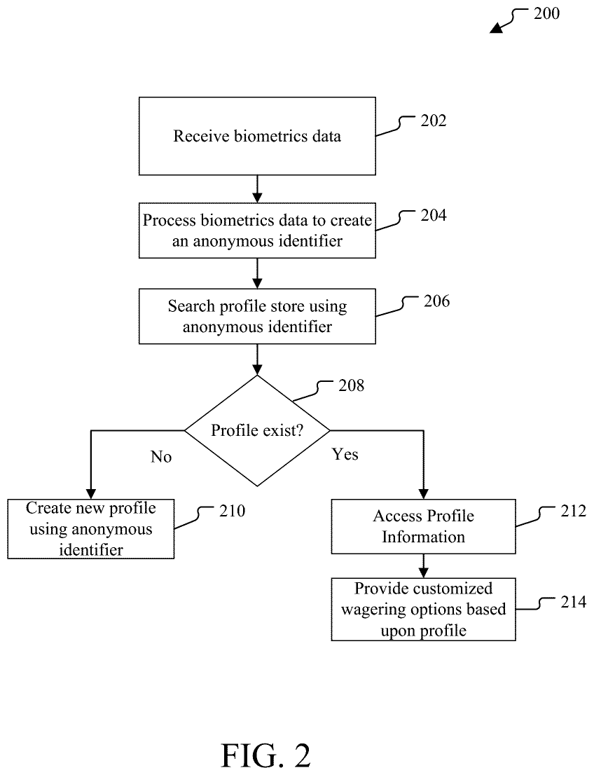

FIG. 2 depicts an exemplary method 200 for identifying an existing risk profile using biometrics information. Flow begins at operation 202 where biometrics information is received. For example, biometrics data can be received from a fingerprint scanner, camera, microphone, etc. that is included as part of a sports wagering kiosk, a mobile device with a wagering application, a device at a sports book, etc. Upon receipt of the biometrics data, flow continues to operation 204 where a unique, anonymous identifier is created using the biometrics data. As discussed, one or more various different processes may be employed to generate the unique identifier, such as by use of a pattern matching algorithm, heuristics, or machine learning models. The processes employed to generate the unique identifier are deterministic. That is, given the same biometrics information, the biometrics analyzer will generate the same unique identifier. In doing so, the biometrics information can be discarded upon generation of the unique identifier.

Upon generating the unique identifier, flow continues to operation 206 where a risk profile datastore is search using the unique identifier to determine if a risk profile exists for the user. At decision operation 209, if a risk profile does note exist, flow branches no to operation 210. At operation 210, a new risk profile is created for the player and associated with the unique identifier generated at operation 204. The new risk profile generated at operation 210 is stored in the risk profile datastore such that it can be retrieved when the player submits future wagers.

Returning to decision operation 208, if a risk profile exists, the risk profile information is accessed at operation 212. As will be discussed in further detail below, the retrieved risk profile can be analyzed to ensure that the player's current wager is in compliance with any jurisdictional legal requirements. In further aspects, flow continues to operation 214 where, upon accessing the risk profile, customized wagering options may be generated and provided to the player. For example, the risk profile accessed at operation 212 can include the player's wager history. The wager history can be used to generate wagering options based upon the players past wagers, for example, by generating wagering options related to the player's favorite team (as determined based upon the player's wagering history), favorite sports, favorite types of bets, etc.

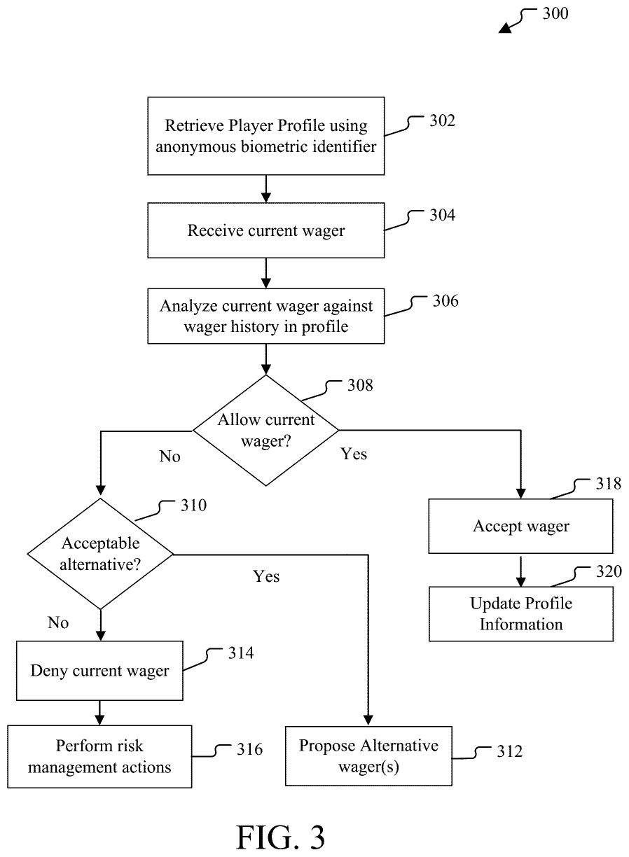

FIG. 3 depicts an exemplary method 300 for determining whether the player's current wager presents a risk in acceptance. As discussed herein, a risk can refer to whether the player's current wager complies with the applicable jurisdictional regulations, compliance procedures, and/or anti-money laundering procedures. One of skill in the art, however, will appreciate that the risk management provided by the method 200 may also be deployed to determine a significant loss may occur or other type of harm will occur to the player or the organization accepting the wager if the player's current wager is accepted. Flow begins at operation 302 where the player's risk profile is retrieved using a unique identifier. As noted, the unique identifier is anonymous. That is, the user cannot be personally identified based upon the unique identifier. The process for retrieving the player's risk profile was previously discussed with respect to the method 200 depicted in FIG. 2. Upon retrieving the profile, flow continues to operation 304 where information about the player's current wager is retrieved. The player's current wager may be retrieved from a sports wagering kiosk, a wagering application, or a wagering system used by a sports book. In aspects, the wager information may be received in addition to the biometric information used to create the unique identifier.

At operation 306, the player's current wager is analyzed against the player's wager history stored in the risk profile. Various different machine learning models, heuristics, and/or pattern matching algorithms may be employed to analyze the player's current wager against player's wager history to determine whether the player's actions comply with the applicable jurisdictional regulations, compliance procedures, and/or anti-money laundering procedures. In examples, different models may be used for different determinations (e.g., a regulation model, a compliance model, an anti-money laundering model, etc.). If the received wager is in compliance, the risk profile can allow the current wager to be placed. Of note, compliance may be determined based upon an individual wager, or upon a series of wagers made by the player. That is, the method 300 is operable to track the player's betting history using the unique identifier. That way, the method 300 is capable of determining if a wager which would be in compliance individually, is actually non-compliant based upon the player's wagering history. If, however, the wager runs afoul of applicable jurisdictional regulations, compliance procedures, and/or anti-money laundering procedures, the wager may be rejected, and one or more risk management actions may be performed. Alternatively, or additionally, responsible gaming tools may be employed to analyze the current wager against the player's wager history to determine, for example, whether to enact limits on the wager or exclusions of the wager.

Based upon the analysis, a determination as to whether to accept the wager is made at decision operation 308, if it is determined to reject the wager, flow branches No to operation 310 where it is determined whether an alternative wager would follow regulations or responsible gaming processes. If an acceptable alternative exists, flow branches Yes to operation 312 and one or more alternative wagers are proposed to the player. If, however, no alternative wagers will comply with regulations or responsible gaming practices, flow branches No to operation 314 where the current wager is denied and the player's risk profile is updated to include information about the denied wager. Flow continues to operation 316, where a risk management action is performed. Example risk management actions may include, but are not limited to, notifying security of the wager, notifying compliance managers, notifying the authorities, etc. For example, a notification with the wager and/or player profile information may be generated and sent to a third-party system associated with security, compliance managers, and/or authorities.

Returning to operation 308, if the analysis of the current wager against the risk profile determines that the current wager can be allowed, flow branches Yes to operation 318 where the current wager is accepted and processed. Flow continues to operation 320 where the player's risk profile is updated to include the current wager.

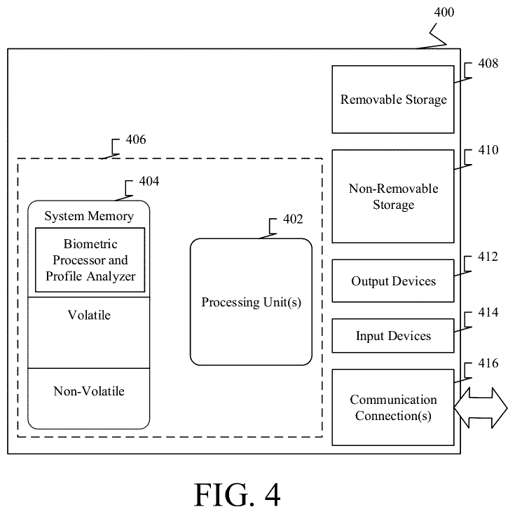

FIG. 4 illustrates a simplified block diagram of a device with which aspects of the present disclosure may be practiced, according to aspects described herein. The device may be a mobile computing device or a VR device for example. One or more of the present embodiments may be implemented in an operating environment 400. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 400 typically includes at least one processing unit 402 and memory 404. Depending on the exact configuration and type of computing device, memory 404 (instructions to perform for performing the aspects disclosed herein) may be volatile (such as RAM), non-volatile (such as ROM, flash memory, etc.), or some combination of the two. This most basic configuration is illustrated in FIG. 4 by dashed line 406. Further, the operating environment 400 may also include storage devices (removable, 408, and/or non-removable, 410) including, but not limited to, magnetic or optical disks or tape. Similarly, the operating environment 400 may also have input device(s) 414 such as remote controller, keyboard, mouse, pen, voice input, on-board sensors, etc. and/or output device(s) 412 such as a display, speakers, printer, motors, etc. Also included in the environment may be one or more communication connections, 416, such as LAN, WAN, a near-field communications network, a cellular broadband network, point-to-point, etc.

Operating environment 400 typically includes at least some form of computer readable media. Computer readable media can be any available media that can be accessed by the at least one processing unit 402 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 400 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a kiosk comprising:
a display operable to display wagering opportunities;
an interface operable to receive a selection of a wagering opportunity; and
a biometric interface operable to receive biometric data; and
a risk profile system comprising:
a biometrics receiver operable to receive the biometric data collected by the biometric interface; and
a biometrics anonymizer, wherein the biometric anonymizer is operable to generate a unique identifier using the biometric data.

2. The system of claim 1, wherein the unique identifier is generated using a deterministic process such that the unique identifier is always generated by the biometric data.

3. The system of claim 2, wherein the unique identifier does not contain any personal identifiable information.

4. The system of claim 2, wherein the unique identifier is generated using a machine learning model trained to generate unique identifiers based upon biometric information.

5. The system of claim 1, further comprising a profile matcher operable to determine whether a user profile exists, wherein the determination is based upon the unique identifier.

6. The system of claim 5, wherein, when the user profile does not exist, the profiling matcher is further operable to:
create a new user profile; and
associate the new user profile with the unique identifier.

7. The system of claim 6, wherein, when the user profile exists, the profiling matcher is further operable to retrieve the user profile from a user profile data store, wherein the user profile comprises historical information for past wagers.

8. The system of claim 7, further comprising a risk profile, wherein the risk profile is operable to:
receive information about a current wager; and
determine a risk associated with the current wager, wherein the determination is based upon the user profile.

9. The system of claim 8, wherein the risk is associated with one or more a jurisdictional regulation, a compliance procedures, or an anti-money laundering procedure.

10. The system of claim 7, wherein risk is determined by analyzing past wagers stored in the user profile against the current wager to determine whether there is risk involved with accepting the new wager.

11. The system of claim 10, when it is determined there is no risk, the risk profiler is further operable to accept the current wager.

12. The system of claim 10, when it is determined there is risk, the risk profiler is further operable to:
reject the current wager; and
perform a risk management action.

13. A method comprising:
generating a unique identifier based upon biometrics information;
accessing a player risk profile using the unique identifier;
analyzing a current wager against the player risk profile to determine whether the current wager is acceptable;
when the current wager is acceptable, accepting the wager; and
when the current wager is not acceptable, denying the wager.

14. The method of claim 13, wherein analyzing the current wager comprises determining whether the current wager complies with one or more of jurisdictional compliance regulations or anti-money laundering regulations.

15. The method of claim 13, wherein generating a unique identifier comprises:
receiving biometric information; and
generating a unique identifier using a deterministic process such that the unique identifier is always generated by the biometric data.

16. The method of claim 15, wherein the unique identifier does not contain any personal identifiable information.

17. A non-tangible computer readable medium storing computer executable instructions that, when executed by at least one processor, cause the at least one processor to perform a method comprising:
generating a unique identifier based upon biometrics information;
accessing a player risk profile using the unique identifier;
analyzing a current wager against the player risk profile to determine whether the current wager is acceptable;
when the current wager is acceptable, accepting the wager; and
when the current wager is not acceptable, denying the wager.

18. The non-tangible computer readable medium of claim 17, wherein generating a unique identifier comprises:
receiving biometric information; and
generating a unique identifier using a deterministic process such that the unique identifier is always generated by the biometric data.

19. The non-tangible computer readable medium of claim 17, wherein the unique identifier is generated using a machine learning model trained to generate unique identifiers based upon biometric information.

20. The non-tangible computer readable medium of claim 17, wherein the unique identifier does not contain any personal identifiable information.
